(19) United States
(12) Patent Application Publication
(10) Pub. No.: US 2006/0037204 A1
(43) Pub. Date: Feb. 23, 2006

(54) Indicator vial

(76) Inventor: Richard J. Gruetzmacher, Colgate, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/207,424

(22) Filed: Aug. 19, 2005

Related U.S. Application Data
(60) Provisional application No. 60/602,950, filed on Aug. 19, 2004.

(51) Int. Cl. G01C 9/24

(52) U.S. Cl. 33/379

(57) ABSTRACT

An indicator vial including a liquid and a colored gas that contrasts with the liquid to provide a highly visible drop or bubble within the vial. The color of the gas is selected to contrast significantly with the liquid. The color of the liquid and of indicia disposed on the exterior of the vial can be selected to further enhance the contrast between the gas and the liquid and/or the indicia, to enhance visibility of the indicator within the vial.

### CROSS-REFERENCE TO RELATED APPLICATIONS

This application claims priority from U.S. Provisional Patent Application Ser. No. 60/602,950 filed on Aug. 19, 2004, and incorporated by reference herein in its entirety.

### FIELD OF THE INVENTION

The present invention relates to an indicator vial such as for use in a tool or other device, and more specifically to an indicator vial including a pair of dissimilarly and contrastingly colored fluids.

### BACKGROUND OF THE INVENTION

Devices incorporating indicator vials, also commonly referred to as bubble vials or level vials, have long been utilized for determining the angle, pitch or slope of a surface or object relative to a predetermined plane. The operation of the indicator vial is predicated on the ability of a user using the device to determine the position of a bubble present within the indicator vial with respect to reference lines located on the vial in order to determine the orientation of a surface or object, as measured by the vial. To provide an accurate indication of the angle, pitch or slope of the surface or object, most indicator vials are formed to include an amount of a liquid disposed within a casing that is securable to the leveling instrument in a desired orientation. The liquid partially fills the casing to form an air bubble that is freely movable within the liquid. In order to aid the user in determining the angle, pitch or slope of the surface or object, on many occasions the liquid positioned within the vial is colored in order to provide a more distinct separation between the air bubble and the liquid in the indicator vial.

However, because the air bubble located within the vial is necessarily clear or transparent, in some circumstances the separation between the liquid and the air bubble is difficult to read since the color of the liquid is viewed directly through the bubble. This can be particularly evident in low light conditions, in which the coloring of the liquid in the vial is not adequate to clearly define the line of separation between the liquid and the air bubble. In such conditions, it is difficult for the user to distinguish the air bubble from the liquid and obtain an accurate reading of the orientation of the object relative to the predetermined plane.

As a result, it is desirable to develop a fluid-type indicator vial that has a high contrast between the indicator and the surrounding liquid, so as to ensure that the indicator is easily visibly distinguishable from the liquid to provide accurate readings as to the orientation of a surface or object.

### SUMMARY OF THE INVENTION

According to a primary aspect of the present invention, an indicator vial includes a body or casing formed of a generally transparent material, and separate amounts of two immiscible fluids disposed within the body or casing. One of the fluids present within the vial is a liquid, and the other fluid is a colored gas that forms a bubble or drop that floats in the liquid within the vial, due to a difference in density between the fluids. The color of the gas, which forms the indicator bubble or drop suspended within and surrounded by the liquid, is selected so as to contrast with the color of the liquid, so that the indicator bubble or drop is therefore easily visible from the exterior of the vial.

Numerous other aspects, features and advantages of the present invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is an isometric view of a representative tool, in the form leveling instrument, incorporating a dual fluid indicator vial constructed according to the present invention;

FIG. 2 is an isometric view of the vial of FIG. 1; and

FIG. 3 is a cross-sectional view along line 3-3 of FIG. 2.

### DETAILED DESCRIPTION OF THE INVENTION

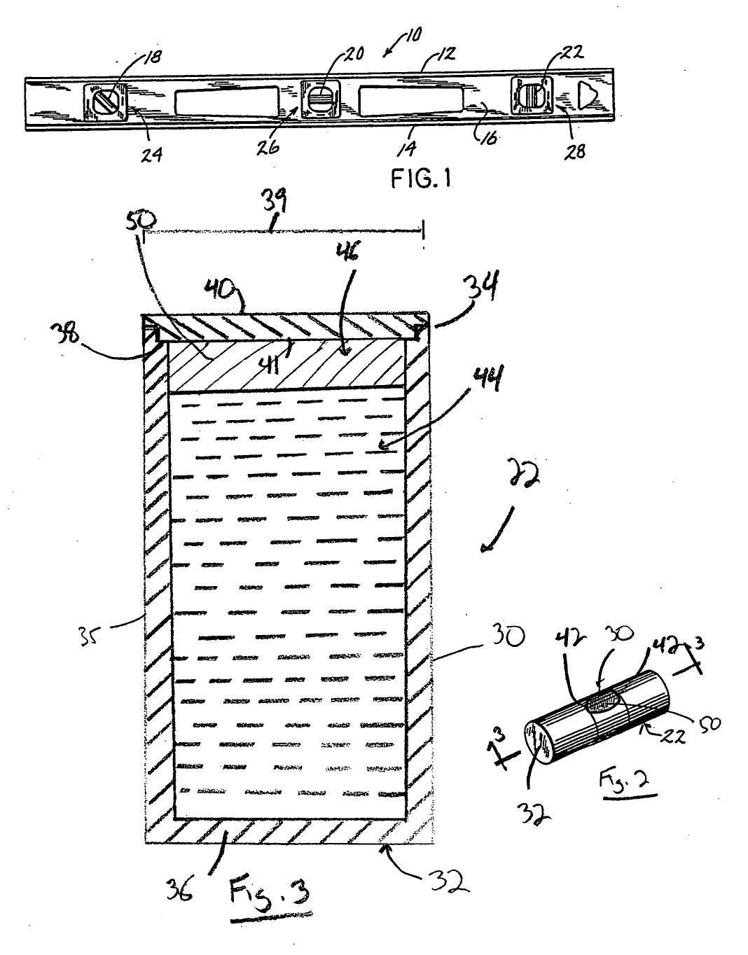

With reference now to the drawing figures in which like reference numerals designate like parts throughout the disclosure, a leveling instrument or tool constructed utilizing the indicator vials of the present disclosure is indicated generally at 10 in FIG. 1. The tool 10 can take any desired or preferred shape, but in one embodiment is in the form of a level that includes an upper rail 12 joined to a lower rail 14 by a web 16. The web 16 extends between the upper rail 12 and lower rail 14 in a manner that positions the upper rail 12 and lower rail 14 parallel to one another, in order to provide flat engaging surfaces that may be positioned on a surface or object (not shown) to determine the orientation of the surface or object relative to a predetermined plane, in a manner as is known.

The web 16 also supports a number of indicator vials 18, 20 and 22 in various angular orientations with respect to the rails 12 and 14. The vials 18, 20 and 22 are maintained in position on the web 16 by respective vial holding members 24, 26 and 28 secured to the web 16 at various locations along the length of the web 16. The holding members 24, 26 and 28 can take any desired form, and can be formed integrally with or separately from the web 16. The holding members 24, 26 and 28 are operable to secure the vials 18, 20 and 22, respectively, to the web 16 in various predetermined orientations relative to rails 12 and 14, in a manner as is known. Representatively, the vials may be positioned to measure the orientation of a surface or object relative to horizontal (level), plumb (vertical), or a predetermined angle therebetween, e.g forty five degrees.

Looking now at FIGS. 2 and 3, the dual fluid indicator vial in accordance with the invention, such as vial 22, includes a body or casing 30 that can be formed of any suitable fluid-impervious material, but is preferably formed of a hard plastic material, such as an acrylic, that is generally transparent, or that at least includes a generally transparent portion through which the interior 31 of the casing 30 can be viewed. The casing 30 can take any number of suitable shapes depending upon the construction of the web 16 and/or the holding members 24, 26 and 28, but is preferably generally cylindrical in shape. The casing 30 is formed to include a closed end 32, an open end 34 disposed opposite the closed end 32, and a side wall 35 that extends between the closed end 32 and the open end 34. The closed end 32 can be formed of a plug 36 secured to one end of the casing 30 by any suitable means, such as by sonic welding or a suitable adhesive, or can be integrally formed with the casing 30. Furthermore, it is also contemplated that the casing 30 can be formed integrally with the web 16 or the holding member 24, 26 or 28, where the web 16 or the holding members 24, 26 or 28 are formed of a suitable material that is transparent, is partially transparent, or that provides for the attachment of a transparent section thereto.

The open end 34 of the casing 30 defines a recessed annular shoulder 38 located within the interior of the casing 30 on which rests a sealing cap 40. The sealing cap 40 is preferably formed of a material similar to the material used to form the casing 30, such that the cap 40 can be affixed over or within the open end 34 by any suitable means, such as an adhesive or by sonic welding, for example. The sealing cap 40 can be formed with an outer diameter 39 that is slightly less than the inner diameter of the casing 30, such that the cap 40 rests completely within the casing 30 on the annular shoulder 38. Alternatively, and as shown in FIG. 3, the cap 40 can have an outer diameter 39 essentially equal to that of the casing 30 and include a section 41 extending outwardly from the cap 40 into engagement with the shoulder 38. In this embodiment, the cap 40 is sealed to the casing along the periphery of the cap 40 and along the periphery of the section 41, to securely seal the open end 34 of the casing 30. However, other alternative constructions for the casing 30 and the cap 40 are also contemplated as being within the scope of the invention.

To assist in measuring the slope, pitch or angle of a surface or object on which the tool 10 is positioned, the casing 30 also includes indicia 42 disposed on the casing 30 between the closed end 32 and open end 34. The indicia 42 is typically in the form of lines that define spaced apart rings on the casing side wall 35. The indicia 42 may be printed on, adhered to or integrally formed with the casing side wall 35, and can be located on the interior or exterior of the side wall 35. The indicia 42 function to provide a visible range on the casing 30 that can be used to determine the orientation of the object or surface against which the tool 10 is placed, in a manner as is known in the art.

Referring now to FIG. 3, the vial 22 contains an amount of a liquid, in the form of a liquid 44, and an amount of a gas, in the form of a gas 46. Liquid 44 partially fills the volume of the casing 30, and gas 46 fills the remainder of the volume of the casing 30. With this construction, gas 46 functions to form a drop or bubble within the interior 31 of casing 30, which interacts with the indicia 42 to provide a visual representation as to the orientation of an object or surface, against which tool 10 is placed, relative to a predetermined plane, such as horizontal, vertical or an angled plane therebetween. The liquid 44 and the gas 46 can be introduced into the vial 22 in any suitable manner as is known in the art. In order to maintain the liquid 44 and gas 46 separate from one another, and thereby to ensure proper operation of the vial 22, the liquid 44 and gas 46 are preferably selected to be completely immiscible with one another. The gas 46 is present in an amount that is less than the amount of the liquid 44, such that the bubble or drop of gas 46 has a size similar to that known in the art. In addition to being completely immiscible with the liquid 44, the gas 46 is also preferably selected such that the gas 46 has a density less than that of the liquid 44, which results in the drop or bubble 50 formed by the gas 46 floating within the liquid 44 in any position of the vial 22. In this manner, the drop or bubble 50 formed of the gas 46 interacts with the indicia 42 on the vial casing side wall 35 to indicate the orientation of the object or surface on which the vial 22 relative to the predetermined plane.

In the present invention, the use of the gas 46 to form the bubble 50 provides certain benefits with regard to the construction of the vial 22. For example, when vial 22 is exposed to elevated temperatures, the liquid 44 within the vial 22 expands. The presence of gas 46 within the interior of vial 22 accommodates such expansion of liquid 44, in that gas 46 compresses under the pressure applied to bubble 50 by the expanding liquid 44. Such compression of gas 46 prevents the expanded liquid 44 from applying pressure to the walls of vial 22, which may otherwise result in breaking or otherwise damaging the vial 22.

The gas 46 is selected so as to be colored, either naturally or artificially, in contrast with the color of liquid 44, so as to visually offset the bubble 50 formed by the gas 46 from the liquid 44. This enables the bubble 50 formed by the gas 46 to more easily be seen in contrast to the liquid 44 and in contrast to the indicia 42. Examples of gases that can be utilized as the gas 46 include various single component, or essentially pure gases such as nitrogen dioxide, tungsten hexafluoride, and chlorine. Each of these gases in relatively pure form has an inherent color that can offset the bubble 50 formed by the gas 46 from, in a preferred embodiment, a clear or lightly colored liquid 44.

While the invention has been shown and described with respect to a specific embodiment, it is understood that various alternatives and modifications are contemplated as being within the scope of the present invention. For example, and without limitation, while the invention has been shown and described in connection with a tubular vial, it should be understood that the invention may take any form in which a colored gas bubble floats in, or is suspended by, a contrastingly colored liquid medium and in which the gas bubble is viewed in order to provide an indication as to the orientation of an object or surface relative to a predetermined plane. This includes any type of tubular vial, such as a straight-walled vial as shown and described, or a pitch-type vial. It is also contemplated that the indicator vial of the invention may be incorporated into a block vial, a bullseye level indicator, etc. It is also contemplated that the gas/liquid characteristics may be selected so that the gas has a density greater than the liquid, so that the indicator droplet or bubble is positioned on the bottom of the vial. In addition, it is understood that the vial of the present invention is not limited for use on a level-type tool as shown, but may be used in any application in which conventional air bubble-type vials are employed, e.g. in other tool products, e.g. drills or the like, automotive applications such as for use in headlight leveling, recreational vehicle or trailer applications for positioning a vehicle or trailer in a level orientation, etc. It is also contemplated that any type of contrasting color scheme may be accomplished using the present invention, e.g. a light colored liquid and a dark colored gas, or a dark colored liquid and a light colored gas, and that various degrees of contrast may be obtained using such color combinations.

Various alternatives of the present invention are contemplated as being within the scope of the following claims particularly pointing out and distinctly claming the subject matter regarded as the invention.

I hereby claim:

1. An indicator vial comprising:
a) an enclosure;
b) a liquid positioned within the enclosure; and
c) a gas positioned within the enclosure and immiscible with the liquid, wherein the gas has a color that contrasts with the liquid.

2. The vial of claim 1, wherein the gas has a density less than that of the liquid to form a floating bubble in the liquid.

3. The vial of claim 1, wherein the gas is present in an amount less than that of the liquid.

4. The vial of claim 1, wherein the gas is selected from a group consisting of nitrogen dioxide, tungsten hexafluoride, and chlorine.

5. The vial of claim 4, wherein the gas is nitrogen dioxide.

6. The vial of claim 1, wherein the gas is inherently colored.

7. The vial of claim 1, wherein the gas is artificially colored.

8. The vial of claim 1, wherein the liquid is colored to contrast with the gas.

9. The vial of claim 8, wherein the liquid has a light color and the gas has a dark color.

10. The vial of claim 1, further comprising indicia disposed on the enclosure that contrast with both the liquid and the gas.

11. A tool comprising:
a) a body; and
b) at least one vial in a predetermined orientation relative to the body, the at least one vial including an enclosure, a liquid positioned within the enclosure, and a gas positioned within the enclosure, wherein the gas has a color that contrasts with the liquid.

12. The tool of claim 11, wherein the gas has a density less than a density of the liquid to form a floating bubble in the liquid.

13. The tool of claim 11, wherein the liquid is colored to contrast with the gas.

14. The tool of claim 13 further comprising indicia disposed on the enclosure that contrasts with both the liquid and the gas.

15. The tool of claim 11, wherein the gas is selected from the group consisting of nitrogen dioxide, tungsten hexafluoride, and chlorine.

16. The tool of claim 11, wherein the gas is a single component gas.

17. A method of making a bubble vial, comprising the acts of:
a) providing an enclosure having a transparent wall and an internal cavity;
b) partially filling the internal cavity with a liquid;
c) placing a gas within the enclosure over the liquid, wherein the gas has a color that contrasts with the liquid; and
d) sealing the enclosure to maintain the liquid and the gas within the enclosure, wherein the gas forms a bubble that floats in the liquid and wherein the contrasting color of the liquid relative to the gas enables the bubble to be viewed through the transparent wall of the enclosure.
